(19) United States
(12) Patent Application Publication
(10) Pub. No.: US 2009/0010131 A1
(43) Pub. Date: Jan. 8, 2009

(54) Assembly Comprising a Component Provided with a Sensitive Part, which Component is Connected to a Base, as Well as an Optical Player Comprising Such an Assembly

(75) Inventors: Waltherus Cornelis Jozef Bierhoff, Eindhoven (NL); Cornelius Antonius Nicolaas Maria Van Der Vleuten, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,092

(22) PCT Filed: Nov. 19, 2004
(86) PCT No.: PCT/IB04/52488

§ 371 Date: May 30, 2006

(30) Foreign Application Priority Data
Dec. 5, 2003 (EP) 03104564.4

(51) Int. Cl. G11B 7/00

(52) U.S. Cl. 369/100; G9B/7

(57) ABSTRACT

Assembly (1) and optical player comprising such an assembly. The assembly is provided with a component (4) provided with a sensitive element (6), which component (4) is connected to a base (3). The base (3) comprises an elongated support surface (5) supporting the component (4), such that the component (4) is connected to said support surface (5) only by a side without said sensitive element. The sensitive element is, for example, a mirror.

The invention relates to an assembly comprising a component provided with a sensitive part, which component is connected to a base with an elongated support surface supporting the component.

The invention furthermore relates to an optical player comprising such an assembly.

A version of such an assembly is known from the Japanese patent application 59-255371. This assembly comprises an optical component provided with a relatively sensitive element, in particular a light-reflecting mirror. Said optical component is connected to a base. The mirror reflects light at an angle of approximately 90°. To prevent the component being moved with respect to the base, a surface of the component which lies against a supporting surface of the base is connected to said supporting surface by means of, for example, glue.

However, for example, shrinkage of glue and variation of glue in volume may bring forces to bear on the optical component as well as on the mirror, owing to which the light-reflecting surface of the mirror will not be located in the desired position with respect to the base. The sensitive part may also be deformed by the forces. Furthermore, differences in coefficient of expansion of the materials of the base and the optical component and variations in temperature will cause other forces to be applied to the optical components such that the optical path of the optical component will not be stable with respect to the base.

It is an object of the invention to provide an assembly in which the influence of the connection between the component and the base on the sensitive element will be minimized.

This object is achieved in that the component is connected to said support surface only by a side remote from said sensitive element.

Since the component is only connected to the support surface by a side remote from said sensitive element, all forces caused by, for example, the shrinkage of glue, forces applied by means of a screw or spring, temperature variations, etc., will only be applied to said side of the component and will not influence the behavior of the sensitive element. Furthermore, it is relatively easy to position the component with respect to the base because the component is well supported by the support surface.

An embodiment of the assembly according to the invention is characterized in that said component is mounted on said base by means of a glue.

The component can be easily connected to the support surface by means of a glue.

A further embodiment of the assembly according to the invention is characterized in that, between said sensitive part and the side connected to the support surface, the assembly is provided with a groove extending between said support surface and the component.

Said groove prevents glue from flowing under the influence of, for example, a hygroscopic effect from the side remote from said sensitive part to a side near said sensitive part, so that the latter side will not be accidentally connected to the support surface.

Another assembly according to the invention is characterized in that the support is provided with the groove.

It is relatively easy to provide the support surface with such a groove, so that the optical component may have a smooth outer surface.

The invention will now be further explained with reference to the drawing in which:

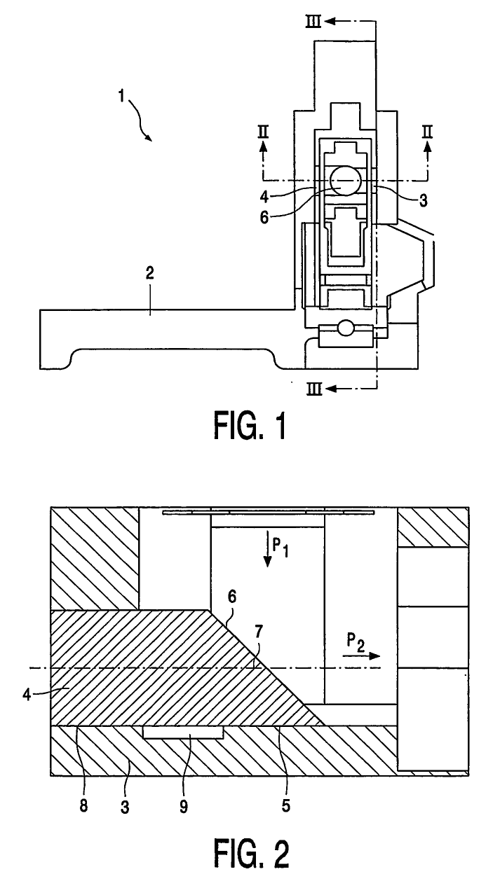

FIG. 1 is a front view of an embodiment of an assembly according to the invention,

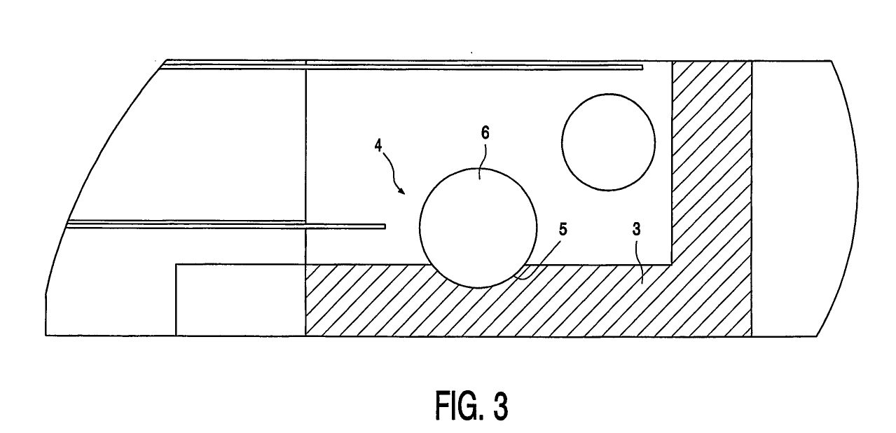

FIG. 2 is an enlarged cross section taken on the line II-II of the assembly of FIG. 1,

FIG. 3 is an enlarged cross section taken on the line III-III of the assembly of FIG. 1, and

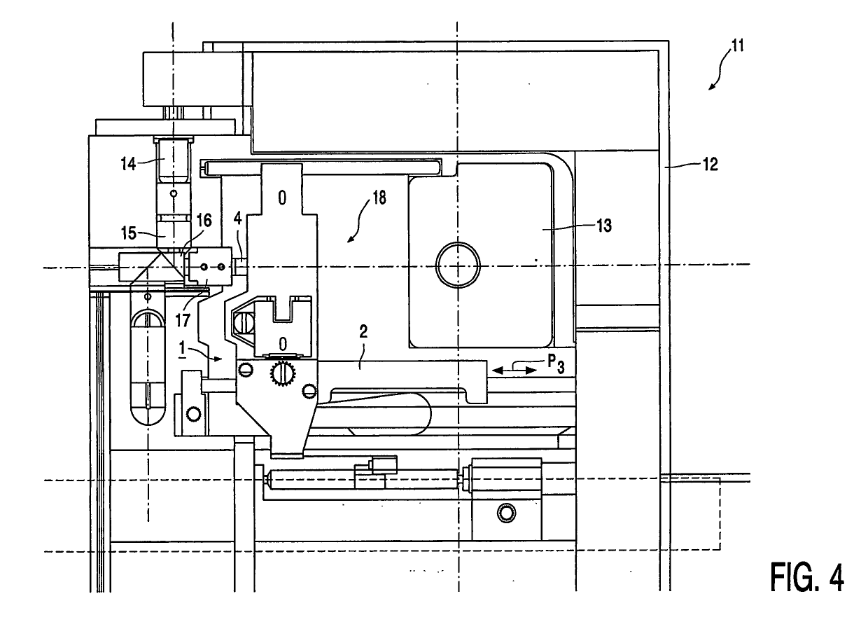

FIG. 4 is a schematic view of an optical player provided with an assembly according to the invention.

Similar reference numbers are being used for similar parts.

FIG. 1 shows an example of an assembly 1 according to the invention, which assembly 1 comprises a frame 2 with a base 3 for an optical component 4. The base 3 comprises an elongated support surface 5. Said support surface 5 has a cylindrical shape similar to the cylindrical shape of the elongated optical component 4. On a first side, said optical component 4 is provided with a chamfered edge 6 extending at an angle of 45° to the longitudinal axis 7 of the optical component 4. The chamfered edge 6 functions as a mirror by means of which light incident on the chamfered edge 6 from the direction P1 is deflected in the direction P2. On a second side remote from said first side of the optical component 4, the base 3 comprises a cylindrical opening in which the second side of the optical component 4 is located. The opening 8 is bounded on one side by the support surface 5. Between the first and second sides of the optical component 4, the base 3 is provided with a groove 9 which forms an interruption of the support surface 5. The optical component 4 is not supported by said support surface 5 near said groove 9.

The optical component 4 is attached to the base 3 by means of a glue applied in the opening 8 of the base 3. Said groove 9 prevents glue from flowing along the entire support surface 5, so that the optical component 4 is not connected to the base 3 near the relatively sensitive chamfered edge 6. Since the optical element 4 is not connected to the base 3 near the chamfered edge 6, no undesired forces or stresses will occur on the optical component 4 due to which the chamfered edge 6 might be deformed. Such stresses can only occur on the second side of said optical component 4 remote by a relatively large distance from the chamfered edge 6.

FIG. 4 shows an example of an; optical player 11 according to the invention comprising a mounting plate 12 on which a motor 13 for driving an optical disc is mounted. The optical player 11 furthermore comprises a light-emitting component, such as a laser 14, as well as optical components 15, 16, 17 which are located in the optical path of the laser 14. The optical player 11 is furthermore provided with a slide 18 that is movable in the directions indicated by the double arrow 18 with respect to the mounting plate 12, which slide 18 is provided with the assembly 1 according to the invention. The optical component 4 of the assembly 1 is located in the same optical path as the optical components 15, 16, 17. During operation of the optical player, an optical disc is rotated by means of the motor 13 whilst a laser beam is emitted by the laser 14 and directed to the optical disc through the optical components 15, 16, 17 and the optical component 4. The light reflected by the optical disc will be directed in a manner known per se to a unit in which the reflected laser beam is analyzed.

It is also possible to connect the optical component 4 to the base 3 by means of a screw or by means of a spring force. In that case the groove 9 is not needed, and the optical component 4 may be supported along the entire support surface 5.

It is also possible to provide the support surface with a V-shaped profile by which the optical component is supported.

It is also possible to provide the groove on the optical component instead of on the support surface.

Since the optical component is being supported along its full length, the component can be readily and accurately aligned with respect to the base.

1. Assembly (1) comprising a component (4) provided with a sensitive part (6), which component (4) is connected to a base (3) with an elongated support surface (5) supporting the component (4), characterized in that the component (4) is connected to said support surface (5) only by a side remote from said sensitive element.

2. Assembly (1) according to claim 1, characterized in that said component (4) is connected to said base (3) by means of a glue.

3. Assembly (1) according to claim 2, characterized in that, between said sensitive part (6) and the side connected to the support surface (5), the assembly (1) is provided with a groove (9) that extends between said support surface (5) and the component (4).

4. Assembly (1) according to claim 3, characterized in that the support is provided with the groove (9).

5. Assembly (1) according to claim 1, characterized in that the sensitive element is a mirror.

6. Assembly (1) according to claim 5, characterized in that the mirror extends at an angle to said support surface (5).

7. Assembly (1) according to claim 1, characterized in that the component (4) is connected to the base (3) by means of a force applied by a screw or spring to said side remote from said sensitive element.

8. Optical player (11) comprising an assembly (1) according to claim 1.
